(19) United States
(12) Patent Application Publication
(10) Pub. No.: US 2009/0276316 A1
(43) Pub. Date: Nov. 5, 2009

(54) INTERACTIVE ADVERTISEMENTS IN A SPONSORED SEARCH ENVIRONMENT

(75) Inventors: Gulshan Verma, Mumbai (IN); Sunil Varhadkar, Mumbai (IN); Sandeep Shrivastava, Bangalore (IN)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/258,859

(22) Filed: Oct. 27, 2008

(30) Foreign Application Priority Data
May 2, 2008 (IN) 1096/CHE/2008

(51) Int. Cl. G06Q 30/00; G06F 7/06; G06F 17/30

(52) U.S. Cl. 705/14.54; 707/4; 707/E17.108; 707/E17.109; 705/14.73; 705/14.58; 707/3; 707/104.1; 707/E17.044

(57) ABSTRACT

A method and system for displaying advertisement listings in a sponsored search environment is provided. The method and system may include receiving at a server located within a network location a search term corresponding to a search request by a searcher via a user terminal; selecting at least one interactive advertisement associated with the search term, where the advertisement may include fields that enable specifying data; generating a search result web page with links to websites associated with the search term as well as the interactive advertisement; and communicating the data specified by the searcher to a processing server. The method may also include selecting interactive advertisements based on the geographic location of the searcher. The processing server may be located at the first or second network location and the interactive advertisements may be stored at the first or second network location.

### CLAIM FOR FOREIGN PRIORITY

This patent application claims the benefit of the filing date under 35 U.S.C. §119(a)-(d) or (f), or §365(b) of Indian Patent Application Serial No. 1096/CHE/2008, filed May 2, 2008, which is incorporated herein by reference.

### BACKGROUND

The Internet has emerged as a powerful tool for finding information. Various search engines are now available that enable searchers, via a web browser, to search for information on a variety of topics. For example, an internet user looking for a specific topic or web page may navigate to a website hosting a search engine and submit a search term, such as “restaurants” to the search engine. After submitting the search term, the search engine may provide a search result list to the internet user. The search result list may include a list of websites, which may include the search term.

These search services may be provided free of charge to the internet user. However, to cover the cost for these services, some search providers may include advertisements within or displayed within proximity to the search result list. Advertisers may pay the search providers to have their advertisements listed along with other websites in the search result list. In some instances, the advertiser's may pay to have their advertisements associated with search terms that may be related to the search terms submitted by the internet user. This may allow the advertiser to target advertisements to internet users that may be more likely to purchase the advertiser's products or services. This type of arrangement has come to be known as sponsored search because the advertisers are essentially sponsoring the internet users search. The search services providing these services have come to be called sponsored search providers.

One problem with existing systems, however, is that a searcher has to navigate through to another website to see exactly what goods and services are being offered by an advertiser. This makes it less likely that the searcher will purchase the goods or services offered by the advertiser.

### BRIEF SUMMARY

To address the problems outlined above, a method and system for displaying advertisement listings in a sponsored search environment is provided. The method and system may include receiving at a server located within a network location a search term corresponding to a search request by a searcher via a user terminal; selecting at least one interactive advertisement associated with the search term, where the advertisement may include fields that enable specifying data; generating a search result web page with links to websites associated with the search term as well as the interactive advertisement; and communicating the data specified by the searcher to a processing server. Interactive advertisements may be selected based on the geographic location of the searcher. The processing server may be located at the first or second network location and the interactive advertisements may be stored at the first or second network location.

The method and system may also include storing, in a database in the network, data associated with a look and feel of the interactive advertisement and programming scripts for controlling the behavior of the interactive advertisement. The interactive advertisement may also be stored within and retrieved from the second network location.

The user terminal may communicate with the processing server via an application program interface that enables communicating data associated with the interactive advertisement to the processing server.

### BRIEF DESCRIPTION OF THE DRAWINGS

FIG. 1 is a diagram of a system for providing a sponsored search result web page with interactive advertisements;

FIG. 2 is a web page with an interactive advertisement;

FIG. 3 is a flow diagram for generating a web page with interactive advertisements;

FIG. 4 is a flow diagram for retrieving an interactive advertisement;

FIG. 5 is a flow diagram of an interactive advertisement communicating with a server; and

FIG. 6 illustrates a general computer system, which may represent any of the computing devices referenced herein.

### DETAILED DESCRIPTION OF THE DRAWINGS AND THE PRESENTLY PREFERRED EMBODIMENTS

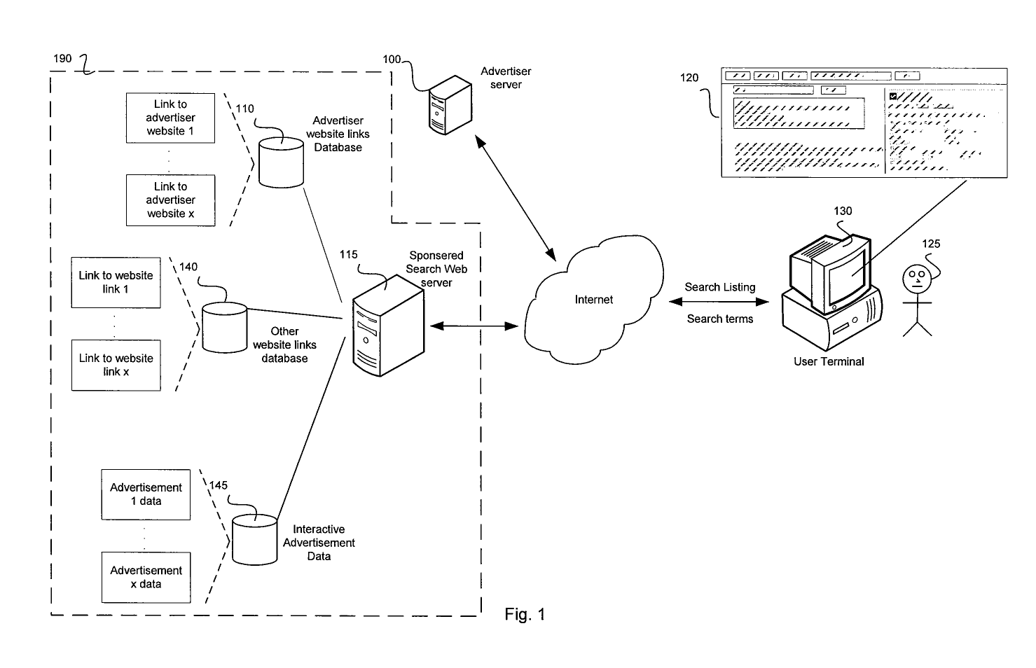

FIG. 1 is a diagram of a system 190 for providing a sponsored search result web page with interactive advertisements. The system 190 includes an advertisement listing database 110, a database with website links 140, an interactive advertisement database 145, and a sponsored search web server 115. Also shown in FIG. 1 is an advertiser server 100, a user terminal 130, a search result web page 120, and a searcher 125.

The sponsored search web server 115 may comprise suitable logic, code, and or circuitry that may enable generating web pages, such as the search result web page 120. The sponsored search web server 115 may be implemented using any conventional computer or other data processing device. The sponsored search web server 115 may further be implemented using a specialized data processing device, which has been particularly adapted to performing the functions of a sponsored search web server 115. These functions may include communicating with a searcher 125 via an internet browsers running on a user terminal 130. The sponsored search web server 115 may also be adapted to communicate with other networked equipment and to retrieve information from various databases, such as the advertisement listing database 110, the database with website links 140, and/or the interactive advertisement database 145. The information communicated may include data defining text, images, video, audio or other information.

The user terminal 130 may comprise suitable logic, code, and or circuitry that may enable communicating information over a network connection, such as an internet connection. The user terminal 130 may be adapted to display web pages communicated from a web server, such as the search result web page 120 generated by the sponsored search web server 115. For example, the user terminal 130 may include an internet browser that may enable displaying web pages. In addition to displaying graphical information, the internet browser may also be utilized to execute instructions. For example, the internet browser may execute instructions in the form of scripts, such as Java script or any other scripting language. The user terminal 130 may also be adapted to communicate search terms to the sponsored search web server 115 and to communicate data to other servers, such as the advertiser server 100.

The advertiser server 100 may comprise suitable logic, code, and or circuitry that may enable communicating information over a network connection, such as an internet connection. The advertiser server 100 may be adapted to communicate with other networked devices via an application program interface (API) that enables sending and receiving information to and from the advertiser server 100. For example, via the API the user terminal 130 and/or the sponsored search web server 115 may communicate data to and from the advertiser server 100. The API may correspond to a set of interface functions for interacting with the advertiser server 100.

The advertiser database 110, the database with website links 140, and the interactive advertisement database 145 may be in communication with to the sponsored search web server 115. The advertiser database 110 may include advertisement listings associated with various advertisers. The advertisement listings may be associated with various search terms. Advertisers may have paid an operator of the sponsored search web server 115 to have their respective advertisement listings associated with various search terms so that their respective advertisement listings may be displayed to a searcher 125 searching for information based on a search term.

The database with website links 140 may include a series of links to other websites as well as search terms that may be incorporated in those websites. The database with website links 140 may, for example, be populated by executing a web crawler algorithm on the internet. This algorithm may search the internet for websites and collect terms found on the websites for association with the website and store links to the websites along with their associated terms.

The interactive advertisement database 145 may include information necessary to generate interactive advertisements. This information may be utilized by the sponsored search web server 115 to generate interactive advertisement in the search result web page 120. The interactive advertisements in the interactive advertisement database 145 may be associated with search terms. Advertisers may have paid an operator of the sponsored search web server 115 to have their respective interactive advertisements associated with various search terms so that their respective advertisement listings may be displayed to a searcher 125 searching for information based on a search term.

The information stored for each interactive advertisement may include data that may enable displaying the interactive advertisements. For example, the data may define the size of the interactive advertisement as well as text to be displayed in the interactive advertisement. The information may also include programming scripts that enable controlling the behavior of the interactive advertisement. Information about a servers API may be provided. This information may be utilized by the programming script so as to enable communication with the server. The programming scripts may be executed on an internet browser operating on the user terminal 130.

In operation, a searcher 125 may, through an internet browser running on a user terminal 130, navigate to a search website hosted on the sponsored search web server 115 and specify search terms. The search terms may be communicated to the sponsored search web server 115, which may then communicate a search result web page 120 to the user terminal 130. The search result web page 120 may include links to advertiser web pages and other web pages that may be related to search terms provided by the searcher 125. The sponsored search web server 115 may accomplish this by searching through the advertisement listing database 110 and the database with website links 140 for any advertisement listings and other websites that may have search terms associated with the search terms provided by the searcher 125. If any are found, the corresponding advertisement listings and links to other websites may be included in the search result web page 120.

In addition, interactive advertisements may be included in the search result web page 120. This may be accomplished by searching through the interactive advertisement database 145 for any interactive advertisements that may be associated with the search terms provided by the searcher 125. The sponsored search web server 115 may take into consideration the geographic location of the searcher 125 and may retrieve interactive advertisements that may be more geographically relevant to the searcher 125. If any are found, the corresponding information stored in the database with interactive advertisement data 145 may be utilized by the sponsored search web server 115 to generate an interactive advertisement. For example, information related to the look and feel of the interactive advertisement may be utilized to generate internet browser code for displaying the interactive advertisement. The sponsored search web server 115 may also include programming scripts in the internet browser code to control the behavior of the interactive advertisement. The code may be executed by the internet browser running on the user terminal 130.

Upon receiving the search result web page 120, the searcher 125 may interact with the interactive advertisement displayed in the search result web page 120. For example, the searcher 125 may enter information into fields in the interactive advertisement. The information entered may then be submitted to a server via an API. For example, the information may be submitted to the sponsored search web server 115 and/or the advertiser server 100. Afterwards, the server may process the information received. The interactive advertisement may be programmed to periodically monitor the server via the API to determine whether the server has completed processing the information received. Once the processing has completed, the interactive advertisement may be programmed to retrieve additional information from the respective server via the API.

The interactive advertisement may enable the purchase of goods or services without the need for navigating away from the search result web page 120. For example, the searcher 125 may search for the term “travel”. The searcher may then be presented with a search result web page 120 with an interactive advertisement that enables the purchase of airline tickets. Via this interactive website the searcher may specify a time and date when he wishes to travel. The interactive advertisement may then update with a list of possible flights from which the searcher 125 may then choose. Upon selecting a flight, the interactive advertisement may then be updated to request a payment method. The searcher 125 may then specify the payment method and purchase a ticket. All of this may occur while the rest of the items on the search result web page 120 remain static, such as the advertisement listings and other website links.

To generate revenue, the owner of the sponsored search web server 115 may charge the advertiser for displaying interactive advertisements in the search result web page 120. Alternatively or in addition, the owner of the sponsored search web server 115 may charge the advertiser when the searcher 125 clicks on the interactive advertisement or when information is communicated from the interactive advertisement to a server, such as the sponsored search web server 115 and/or the advertiser server 100. This may, for example, be accomplished by communicating a message from the user terminal 130 to the sponsored search web server 115 when the searcher clicks the interactive advertisement and deducting a money amount from an advertiser account associated with the interactive advertisement when the searcher 125 has clicked on the interactive advertisement.

At least one advantage of this approach is that the searcher 125 does not have to navigate to another website to obtain the goods or services offered through the interactive advertisement. This increases the likelihood of the searcher 125 purchasing the goods or services offered by the owner of the interactive advertisement.

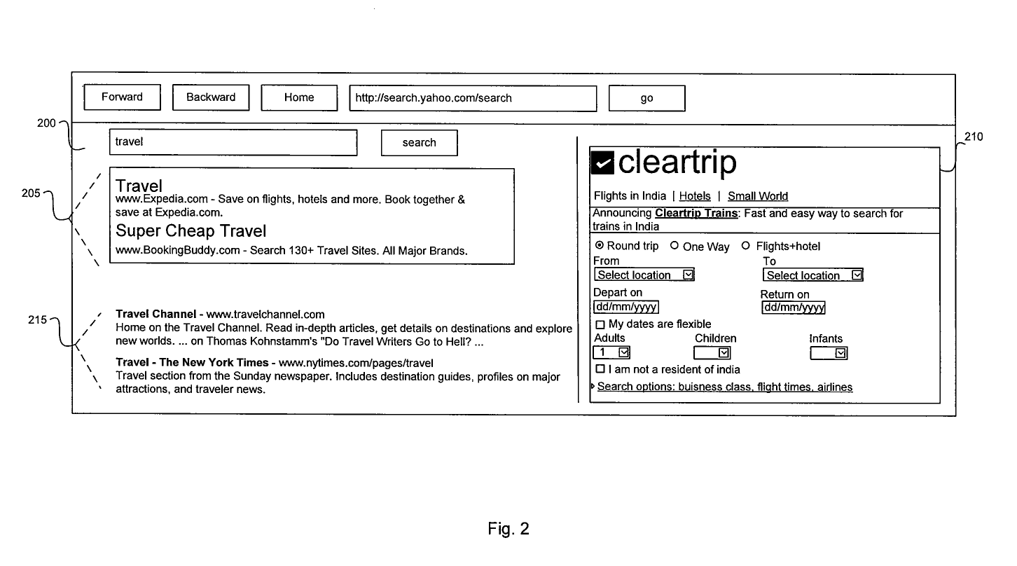

FIG. 2 is a web page with an interactive advertisement that may correspond to the search result web page 120 shown in FIG. 1. Shown in FIG. 2, is a search result web page 200, a group of advertisement listings 205, a group of other web page listings 215, and an interactive advertisement 210. The search result list web page 200 may be displayed via an internet browser operating on a user terminal 130 in response to a search term being provided by a searcher 125. For example, the searcher 125 may have submitted the search term “travel” to a search engine, such as the sponsored search web server 115 shown in FIG. 1. The sponsored search web server 115 may then communicate the search result list web page 200 to an internet browser running on the user terminal 130. The group of advertisement listings 205 and the group of other web page listings 215 may correspond to web pages that include the search term that may be stored in the advertisement listing database 110 and database with website links 140 respectively. For example, a particular web page may include the text “travel” or an advertisement link may be associated with the text “travel.” As a result, links corresponding to web pages and advertisements may be shown in the search result web page 200.

The interactive advertisement 210 may correspond to an advertisement that allows a searcher 125 to interact with the advertisement. For example, in response to the search term “travel”, the interactive advertisement 210 shown may be that of a travel related advertisement with input fields that allow a searcher to specify the parameters of a trip. The searcher 125 may be able to specify a location where he is traveling from and a location that he wishes to travel to. The searcher may also be able to specify other parameters, such as the relevant dates and the number of travelers.

A programming script may run in the background and may control the behavior of the interactive advertisment. For example, the programming script may be utilized to verify that the searcher entered the correct type of data into a field. The programming script may also enable communicating information in the fields to a server, such as the sponsored search web server 115 or the advertiser server 100. The programming script may accomplish this by sending the information in the fields via an API associated with the server.

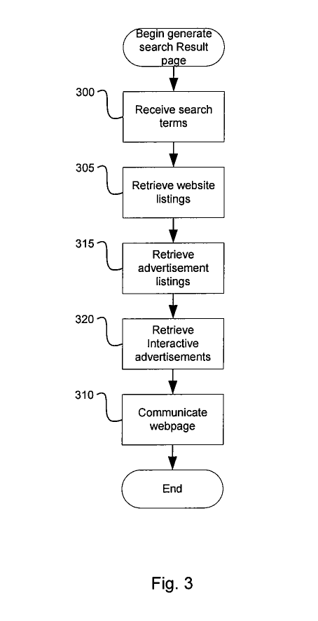

FIG. 3 is a flow diagram for generating a web page with interactive advertisements. The blocks shown in the flow diagram may be implemented by the sponsored search web server 115 in generating the search result web page 120 shown in FIG. 1. Referring to FIG. 3, at block 300 search terms may be received. For example, the sponsored search web server 115 may via a network connection receive search terms specified by a searcher 125. The searcher 125 may have specified the search terms via an internet browser running on a user terminal 130.

At block 305, the database with website links 140 may be searched to find links to web pages on the internet that include the search term. At block 315 the advertisement listing database 110 may be searched to find advertisement listings associated with the search term. Advertisers may have paid to have their respective advertisement listings shown to a searcher submitting a particular search term.

At block 320, interactive advertisements may be retrieved from the interactive advertisement database 145. An advertiser may have paid to have his interactive advertisement displayed to a searcher in response to a particular search term. For example, an advertiser may have paid to have the search term “travel” associated with an interactive advertisement such as the interactive advertisement shown in FIG. 2.

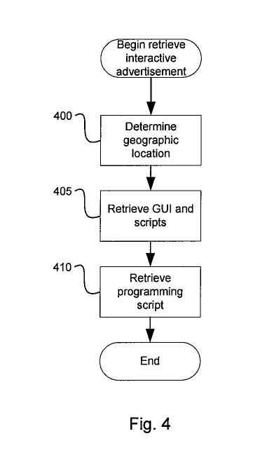

FIG. 4 is a flow diagram for retrieving an interactive advertisement. At block 400, a geographic location of the searcher 125 may first be determined. This may be accomplished by retrieving the internet address of the searcher 125 and determining, based on the address, the relative location of the searcher 125.

At block 405, data related to the look and feel of the interactive advertisement may be retrieved. This information may, for example, specify the size of the interactive advertisement in pixels. It may also specify text and the location of text in the interactive advertisement.

At block 410, programming scripts for controlling the behavior of the interactive advertisement may be retrieved. For example, the programming scripts may be utilized to limit the type of data the searcher 125 may input into a field. The programming script may also enable communication with a server via the server's API. The API may correspond to an interface specification that defines the way in which to communicate information to a server, such as the sponsored search web server 115 or advertiser server 100. The API may be different for different interactive advertisements.

Referring back to FIG. 3, at block 310 a web page including the websites retrieved at block 305, the advertisements listings retrieved at block 315, and the interactive advertisements retrieved at block 302 may be generated and communicated to the searcher. For example, a web page such as the web page shown in FIG. 2 may be communicated to the searcher 125. This web page may include programming scripts for controlling the behavior of the interactive advertisement.

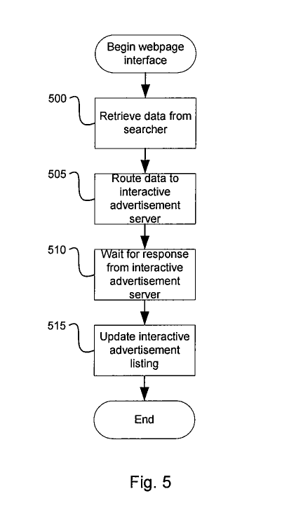

FIG. 5 is a flow diagram of an interactive advertisement communicating with a server. At block 500, a searcher 125 may enter data into the fields of the interactive advertisement, such as the interactive advertisement 210 in FIG. 2. For example, the searcher 125 may specify a date on which he is traveling. At block 505, a program script corresponding to the interactive advertisement may communicate the data entered to a server via the server's API. For example, the data may be communicated to the sponsored search web server 115 and/or the advertiser server 100.

At block 510, the program script may wait for a response from the server. For example, the program script may poll the server via an API function the returns the processing status of the server. At block 515, the server may have completed processing the information. The program script may then retrieve information from the server. For example, the information may include flights available on the date entered by the searcher 125. This information may then be shown to the searcher 125.

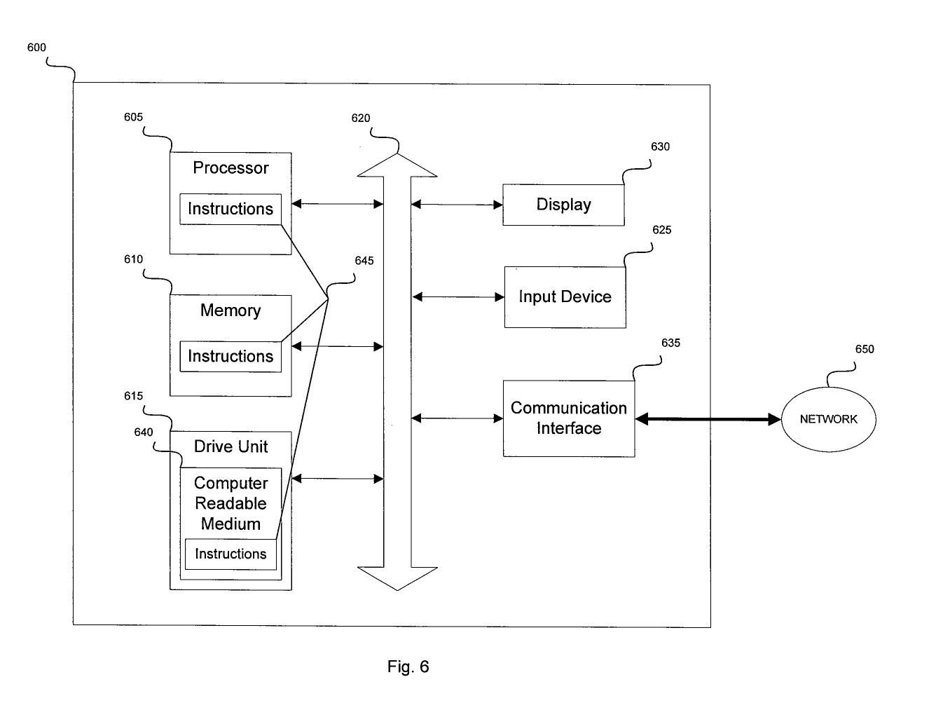

FIG. 6 illustrates a general computer system, which may represent a sponsored search web server 115, user terminal 130, advertiser server 100, or any of the other computing devices referenced herein. The computer system 600 may include a set of instructions 645 that may be executed to cause the computer system 600 to perform any one or more of the methods or computer based functions disclosed herein. The computer system 600 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 645 (sequential or otherwise) that specify actions to be taken by that machine. In one embodiment, the computer system 600 may be implemented using electronic devices that provide voice, video or data communication. Further, while a single computer system 600 may be illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 605, such as, a central processing unit (CPU), a graphics processing unit (GPU), or both. The processor 605 may be a component in a variety of systems. For example, the processor 605 may be part of a standard personal computer or a workstation. The processor 605 may be one or more general processors, digital signal processors, application specific integrated circuits, field programmable gate arrays, servers, networks, digital circuits, analog circuits, combinations thereof, or other now known or later developed devices for analyzing and processing data. The processor 605 may implement a software program, such as code generated manually (i.e., programmed).

The computer system 600 may include a memory 610 that can communicate via a bus 620. For example, the advertisement listing database 110, database with website links 140, and interactive advertisement database may be stored in the memory. The memory 610 may be a main memory, a static memory, or a dynamic memory. The memory 610 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 610 may include a cache or random access memory for the processor 605. Alternatively or in addition, the memory 610 may be separate from the processor 605, such as a cache memory of a processor, the system memory, or other memory. The memory 610 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 610 may be operable to store instructions 645 executable by the processor 605. The functions, acts or tasks illustrated in the figures or described herein may be performed by the programmed processor 605 executing the instructions 645 stored in the memory 610. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 600 may further include a display 630, such as a liquid crystal display (LCD), an organic light emitting diode (OLED), a flat panel display, a solid state display, a cathode ray tube (CRT), a projector, a printer or other now known or later developed display device for outputting determined information. The display 630 may act as an interface for the user to see the functioning of the processor 605, or specifically as an interface with the software stored in the memory 610 or in the drive unit 615.

Additionally, the computer system 600 may include an input device 630 configured to allow a user to interact with any of the components of system 600. The input device 625 may be a number pad, a keyboard, or a cursor control device, such as a mouse, or a joystick, touch screen display, remote control or any other device operative to interact with the system 600.

The computer system 600 may also include a disk or optical drive unit 615. The disk drive unit 615 may include a computer-readable medium 640 in which one or more sets of instructions 645, e.g. software, can be embedded. Further, the instructions 645 may perform one or more of the methods or logic as described herein. The instructions 645 may reside completely, or at least partially, within the memory 610 and/or within the processor 605 during execution by the computer system 600. The memory 610 and the processor 605 also may include computer-readable media as discussed above.

The present disclosure contemplates a computer-readable medium 640 that includes instructions 645 or receives and executes instructions 645 responsive to a propagated signal; so that a device connected to a network 650 may communicate voice, video, audio, images or any other data over the network 650. The instructions 645 may be implemented with hardware, software and/or firmware, or any combination thereof. Further, the instructions 645 may be transmitted or received over the network 650 via a communication interface 635. The communication interface 635 may be a part of the processor 605 or may be a separate component. The communication interface 635 may be created in software or may be a physical connection in hardware. The communication interface 635 may be configured to connect with a network 650, external media, the display 630, or any other components in system 600, or combinations thereof. The connection with the network 650 may be a physical connection, such as a wired Ethernet connection or may be established wirelessly as discussed below. Likewise, the additional connections with other components of the system 600 may be physical connections or may be established wirelessly.

The network 650 may include wired networks, wireless networks, or combinations thereof. Information related to business organizations may be provided via the network 650. The wireless network may be a cellular telephone network, an 802.11, 802.16, 802.20, or WiMax network. Further, the network 650 may be a public network, such as the Internet, a private network, such as an intranet, or combinations thereof, and may utilize a variety of networking protocols now available or later developed including, but not limited to TCP/IP based networking protocols.

The computer-readable medium 640 may be a single medium, or the computer-readable medium 640 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 640 may include a solid-state memory such as a memory card or other package that houses one or more non-volatile read-only memories. The computer-readable medium 640 also may be a random access memory or other volatile re-writable memory. Additionally, the computer-readable medium 640 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The method and system may also be embedded in a computer program product, which included all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

From the foregoing, it may be seen that the embodiments disclosed herein provide an approach for providing interactive advertisements in a sponsored search environment. Rather than simply displaying a static advertisement listings and requiring the searcher to navigate away from the search result page, this approach provides an interactive advertisement within the search result page. The interactive advertisement enables the user to interact with the advertisement without leaving the search result web page. This improves the likelihood that the searcher may utilized the services provided by the owner of the interactive advertisement.

While the method and system has been described with reference to certain embodiments, it will be understood by those skilled in the art that various changes may be made and equivalents may be substituted without departing from the scope. In addition, many modifications may be made to adapt a particular situation or material to the teachings without departing from its scope. Therefore, it is intended that the present method and system not be limited to the particular embodiment disclosed, but that the method and system include all embodiments falling within the scope of the appended claims.

1. A method for displaying advertisements in a sponsored search environment, the method comprising:
receiving at a server located within a network location a search term corresponding to a search request by a searcher via a terminal;
selecting at least one interactive advertisement associated with the search term, wherein the at least one interactive advertisement comprises at least one field that enables specifying data by the searcher;
generating a search result comprising links to websites associated with the search term and the selected at least one interactive advertisement; and
communicating the data associated with the at least one field to a processing server after the searcher has specified the data.

2. The method according to claim 1, wherein selecting further comprises determining a geographic location of the searcher and selecting interactive advertisements that are geographically relevant to the searcher.

3. The method according to claim 1, wherein the interactive advertisement is stored at the network location.

4. The method according to claim 1, wherein the processing server is located at the first network location.

5. The method according to claim 1, wherein the terminal communicates with the processing server via an application program interface that enables communicating data associated with the interactive advertisement to the processing server.

6. The method according to claim 1, wherein the processing server is located at a second network location.

7. The method according to claim 6, further comprising storing the interactive advertisement within the second network location and retrieving the interactive advertisement from the second network location.

8. The method according to claim 1, further comprising storing in a database in the network data associated with a look and feel of the interactive advertisement and programming scripts for controlling the behavior of the interactive advertisement.

9. A machine-readable storage medium having stored thereon, a computer program comprising at least one code section for displaying advertisements in a sponsored search environment, the at least one code section being executable by a machine for causing the machine to perform acts of:
receiving at a server located within a network location a search term corresponding to a search request by a searcher via a terminal;
selecting at least one interactive advertisement associated with the search term, wherein the at least one interactive advertisement comprises at least one field that enables specifying data by the searcher;
generating a search result comprising links to websites associated with the search term and the selected at least one interactive advertisement; and
communicating the data associated with the at least one field to a processing server after the searcher has specified the data.

10. The machine-readable storage medium according to claim 9, wherein selecting further comprises determining a geographic location of the searcher and selecting interactive advertisements that are geographically relevant to the searcher.

11. The machine-readable storage medium according to claim 9, wherein the interactive advertisement is stored at the network location.

12. The machine-readable storage medium according to claim 9, wherein the processing server is located at the first network location.

13. The machine-readable storage medium according to claim 9, wherein the terminal communicates with the processing server via an application program interface that enables communicating data associated with the interactive advertisement to the processing server.

14. The machine-readable storage medium according to claim 9, wherein the processing server is located at a second network location.

15. The machine-readable storage medium according to claim 14, wherein the at least one code section comprises code that enables storing the interactive advertisement within the second network location and retrieving the interactive advertisement from the second network location.

16. The machine-readable storage medium according to claim 9, wherein the at least one code section comprises code that enables storing in a database in the network data associated with a look and feel of the interactive advertisement and programming scripts for controlling the behavior of the interactive advertisement.

17. A system for displaying advertisements in a sponsored search environment, the system comprising:
a receiver configured to receive at a server located within a network location a search term corresponding to a search request by a searcher via a terminal;
a selector, in communication with the receiver configured to select at least one interactive advertisement associated with the search term, wherein the at least one interactive advertisement comprises at least one field that enables specifying data by the searcher;
a search result generator in communication with the selector, configured to generate a search result comprising links to websites associated with the search term and the selected at least one interactive advertisement; and
a transmitter in communication with the search result list generator configured to communicate the data associated with the at least one field to a processing server after the searcher has specified the data.

18. The system according to claim 17, wherein selecting further comprises determining a geographic location of the searcher and selecting interactive advertisements that are geographically relevant to the searcher.

19. The system according to claim 17, wherein the interactive advertisement is stored at the network location.

20. The system according to claim 17, wherein the processing server is located at the first network location.

21. The system according to claim 17, wherein the terminal communicates with the processing server via an application program interface that enables communicating data associated with the interactive advertisement to the processing server.

22. The system according to claim 17, wherein the processing server is located at a second network location.

23. The system according to claim 22, further comprising circuitry that enables storing the interactive advertisement within the second network location and retrieving the interactive advertisement from the second network location.

24. The system according to claim 17, further comprising circuitry that enables storing in a database in the network data associated with a look and feel of the interactive advertisement and programming scripts for controlling the behavior of the interactive advertisement.

25. A method for displaying advertisements in a sponsored search environment, the method comprising:
receiving at a server located within a network location a search term corresponding to a search request by a searcher via a terminal;
selecting at least one interactive advertisement associated with the search term, wherein the at least one interactive advertisement comprises at least one field that enables specifying data by the searcher;
generating a search result comprising links to websites associated with the search term and the selected at least one interactive advertisement;
communicating the data associated with the at least one field to a processing server after the searcher has specified the data; and
changing at least at least some portions of the interactive advertisement in response to communicating the data.
